(19) United States
(12) Patent Application Publication
(10) Pub. No.: US 2008/0308389 A1
(43) Pub. Date: Dec. 18, 2008

(54) ROLLER CONVEYOR AND CONVEYANCE CONTROL METHOD

(75) Inventor: Tadashi Inoue, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/106,529

(22) Filed: Apr. 21, 2008

(30) Foreign Application Priority Data
Jun. 13, 2007 (JP) 2007-156431

(51) Int. Cl. B65G 43/00; B65G 13/06

(52) U.S. Cl. 198/617; 198/788

(57) ABSTRACT

A roller conveyor is disclosed that constitutes a conveying path with plural rollers arranged in parallel. The roller conveyor includes the plural rollers in alignment with one another on both sides of the conveying path, and a roller driving motor provided to each of the rollers. In the roller conveyor, the rollers are directly linked to rotary shafts of the corresponding roller driving motors.

### BACKGROUND OF THE INVENTION

1. Field of the Invention

The present invention relates generally to roller conveyors and, more specifically, to a roller conveyor that drives each of plural rollers to convey a conveyed object.

2. Description of the Related Art

Roller conveyors constituting a conveying path with plural rollers continuously arranged in parallel are called free-flow conveyors, and they are often used, for example, to convey palettes having a manufactured object mounted thereon in manufacturing facilities.

Such a roller conveyor is provided with a driving force transmission mechanism for transmitting the driving force of a motor to each roller. Examples of the driving force transmission mechanism include a mechanism using a train of gears, a mechanism using pulleys and a belt, a mechanism using a timing belt or a chain, etc.

When the roller conveyor provided with the above driving force transmission mechanism is used, for example, in a clean room, dust (minute powder particles) generated by the driving force transmission mechanism may pollute the clean environment inside the clean room. In other words, when the train of gears is used as the driving force transmission mechanism, abrasion powder generated at a part where the gears are meshed with each other may be scattered to surroundings. Moreover, when the pulleys and the belt are used as the driving force transmission mechanism, abrasion powder resulting from the sliding of the belt on the pulleys may be scattered to the surroundings.

In order to prevent such a scattering problem of abrasion powder, a method has been disclosed in which the driving force transmission mechanism is arranged in a space isolated from the clean environment so as to exhaust and remove minute powder particles generated by the driving force transmission mechanism. Furthermore, another method has been disclosed in which water is dropped onto the driving force transmission mechanism to wash out minute powder particles so as not to be scattered in the air.

However, the above methods require large-scale installations such as providing an isolated space and an exhaust unit or water supplying and collecting units, causing a great deal of inconvenience to users who use the roller conveyor in the clean room with a limited space.

Accordingly, a roller conveyor has been proposed that has a mechanism for directly linking motors with plural rollers and synchronizing the rotations of the plural motors to rotate the rollers (see, for example, Patent Document 1). In this case, because the rollers are directly driven by the corresponding motors, the driving force transmission mechanism is not required. As a result, the scattering of minute powder particles due to the abrasion of components of the driving force transmission mechanism does not occur.

Patent Document 1: JP-A-2004-131222

### SUMMARY OF THE INVENTION

The roller conveyor of Patent Document 1 can provide a configuration without the driving force transmission mechanism, but both ends of the rollers are supported by bearings. Therefore, abrasion powder may be generated by the bearings.

Furthermore, in order to stop a conveyed object midway through a conveying path, the provision of stoppers along the conveying path is required. The stopper serves as a mechanism for hitting, for example, against a pallet having a conveyed object mounted thereon to forcibly stop the same. However, the provision of many stoppers along the conveying path causes an increased cost of the roller conveyor.

In addition, although the roller conveyor can stably convey a conveyed object at a constant speed because it synchronizes the plural rollers to rotate at a constant speed, it cannot change the conveying speed of the conveyed object midway through the conveying path. For example, if cycle time is different for each manufacturing process in a case where a manufactured object is conveyed between the processes, it is preferable that the conveying speed between the processes be variable. However, the roller conveyor does not have such control over the conveying speed.

The present invention has been made in view of the above problems and may provide a roller conveyor that reduces the scattering of dust due to the driving of rollers.

Also, the present invention may provide a roller conveyor capable of partially controlling a conveying speed midway through a conveying path and a conveyance control method using the roller conveyor.

In order to attain the above object, according to one aspect of the present invention, there is provided a roller conveyor constituting a conveying path with plural rollers arranged in parallel. The roller conveyor comprises the plural rollers in alignment with one another on both sides of the conveying path; and a roller driving motor provided to each of the rollers, wherein the rollers are directly linked with rotary shafts of the corresponding roller driving motors.

Also, according to another aspect of the present invention, there is provided a conveyance control method for controlling the conveyance of plural conveyed objects in a conveying path formed by connecting plural roller conveyor units to each other, each roller conveyor unit being composed of the above roller conveyors, wherein one of the plural conveyed objects on the conveying path is stopped at a first roller conveyor unit among the plural roller conveyor units, while another conveyed object on a second roller conveyor unit among the plural roller conveyor units is conveyed across the first roller conveyor unit.

According to an embodiment of the present invention, a roller driving motor is provided to each of the plural rollers, and the rotary shafts of the roller driving motors are directly linked with the corresponding rollers. Therefore, the rollers are supported and rotated by the roller driving motors. Accordingly, a driving force transmission mechanism for transmitting a driving force to the rollers and bearings for rotatably supporting the rollers are not required. As a result, the scattering of minute powder such as abrasion powder generated by a driving force transmission mechanism and the bearings does not occur, thereby making it possible to maintain a clean environment around the roller conveyor.

In addition, because the driving of the rollers can be separately controlled, the conveyance of a conveyed object can be separately controlled midway through the conveying path, thereby making it possible to efficiently convey plural conveyed objects and reduce the entire conveying time.

### BRIEF DESCRIPTION OF THE DRAWINGS

Other objects, features and advantages of the present invention will become more apparent from the following detailed description when read in conjunction with the accompanying drawings, in which:

FIG. 1 is a perspective view of a roller conveyor according to an embodiment of the present invention;

FIG. 2 is a simplified cut-open view of a part of a side-wall plate to which a roller driving motor is attached;

FIGS. 3A and 3B are diagrams showing examples of a conveyance control method for pallets in a case where roller conveyor units are connected to one another to form a conveying path; and

FIG. 4 is a flowchart for explaining the conveyance control method shown in FIG. 3A.

### DETAILED DESCRIPTION OF THE PREFERRED EMBODIMENTS

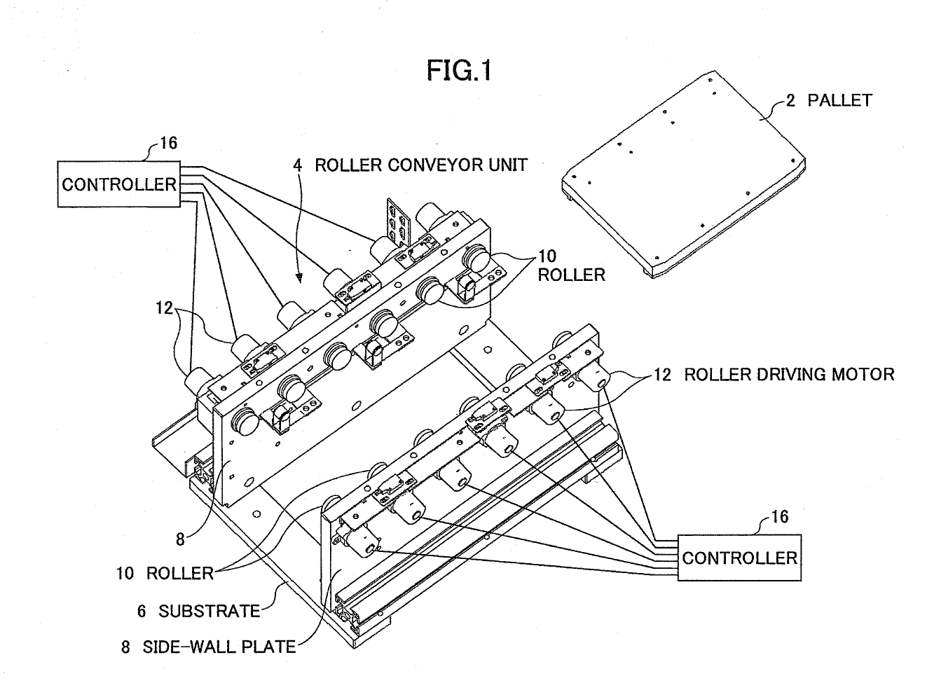

Referring to the accompanying drawings, a description is made of a roller conveyor according to an embodiment of the present invention. FIG. 1 is a perspective view of the roller conveyor according to the embodiment. The roller conveyor shown in FIG. 1 is a so-called free-flow conveyor and configured such that plural rollers are rotated to convey a pallet 2 while the pallet 2 is supported by the rollers. A conveyed object is mounted on the pallet 2 and conveyed together with the pallet 2.

The roller conveyor shown in FIG. 1 is configured as a roller conveyor unit 4 in which six pairs of the rollers 10 are arranged one roller of each of the pairs on each side of a conveying path. In manufacturing lines, etc., plural of the roller conveyor units 4 are arranged side by side along the conveying path to form a long conveying path.

The roller conveyor unit 4 has side-wall plates 8 that are arranged in parallel at a predetermined interval while standing on a substrate 6. The conveying path is formed between the side-wall plates 8. The rollers 10 are in alignment with one another inside, or on the conveying path side of, the left and right side-wall plates 8. In an example shown in FIG. 1, six rollers 10 are arranged inside one side-wall plate 8 and another six rollers 10 are arranged inside the other side-wall plate 8 at facing positions.

Each of the rollers 10 is not a long roller extending over the entire width of the conveying path, but it has a length only to support the ends of the pallet 2. In other words, the pallet 2 is conveyed with its left and right ends supported by the rollers 10 in a conveying direction.

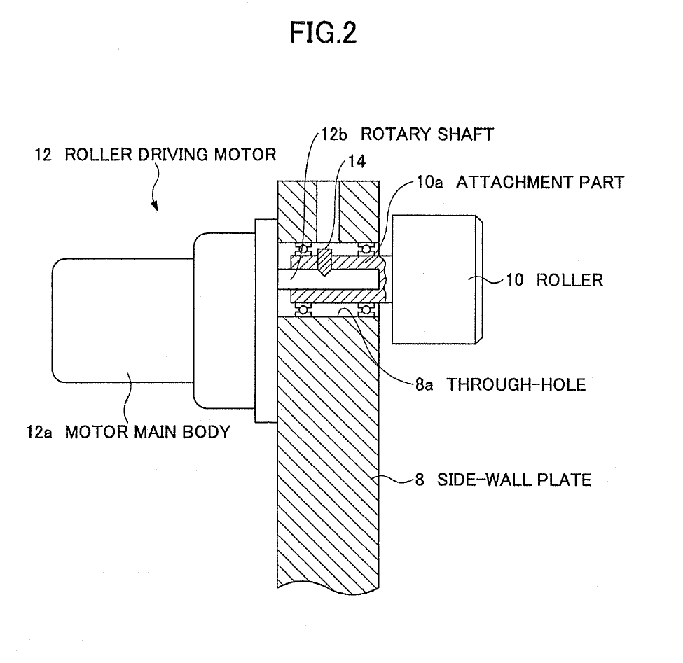

On the sides of the side-wall plates opposite from the rollers 10, roller driving motors 12 are arranged. FIG. 2 is a simplified cut-open view of a part of the side-wall plate 8 to which the roller driving motor 12 is attached. The motor main body 12a of the roller driving motor 12 is fixed to the side-wall plate 8 by screws, etc. The rotary shaft 12b of the roller driving motor 12 is arranged to extend in a through-hole 8a of the side-wall plate 8.

The roller 10 has a cylindrical attachment part 10a that is to be inserted in the through-hole 8a of the side-wall plate 8. A hole is formed in the attachment part 10a, and the rotary shaft 12b of the roller driving motor 12 extending in the through-hole 8a fits in the hole. The rotary shaft 12b is inserted in the hole and fixed by a screw 14. Each of the left and right side-wall plates 8 has six roller driving motors 12 attached, and the six rollers 10 are attached to the rotary shafts 12b of the corresponding roller driving motors 12.

The motor main body 12a of the roller driving motor 12 has a motor and a reduction mechanism, and the rotary shaft 12b is rotated at a rotational speed reduced by the reduction mechanism. As the motor 12, a synchronous motor such as an induction motor capable of being frequency controlled regarding the number of rotations or a pulse motor is available. The roller driving motor 12 is electrically connected to a controller 16 and driven by current supplied from the controller 16. The controller 16 is configured to separately control the driving or rotational speed of each of the roller driving motors 12.

When the induction motor is used as the roller driving motor 12, the controller 16 has a frequency control power unit. The frequency control power unit separately controls the frequency of current to be supplied to the twelve roller driving motors 12. Accordingly, the controller 16 can separately control the rotational speeds of the twelve rollers 10. In general, because the corresponding rollers 10 on left and right sides may be rotated at the same speed, it is only required to supply current having the same frequency to a pair of the left and right roller driving motors 12.

Moreover, when a pulse motor is used as the roller driving motor 12, the controller 16 has a pulse control power unit. The pulse control power unit separately controls pulse currents to be supplied to the twelve roller driving motors 12. Accordingly, the controller 16 can separately control the rotational speeds of the twelve rollers 10. In general, because the corresponding rollers 10 on left and right sides may be rotated at the same speed, it is only required to supply the same pulse current to a pair of the left and right roller driving motors 12.

According to the roller conveyor having the above configuration, one roller driving motor 12 is provided to one roller 10, and the roller 10 is directly linked to the rotary shaft 12b of the roller driving motor 12. Therefore, a driving force transmission mechanism is not required. As a result, the scattering of dust such as minute powder particles due to the abrasion of components of a driving force transmission mechanism does not occur. Furthermore, because the roller 10 is supported and rotated by the rotary shaft 12b of the roller driving motor 12, a bearing for rotatably supporting the roller 10 need not be provided. As a result, the scattering of dust such as minute powder particles due to the abrasion of components of the bearing does not occur.

As described above, the roller conveyor unit 4 according to the embodiment does not cause the scattering of dust such as minute powder particles to the surroundings. Therefore, it is suitable for conveying a conveyed object while maintaining a clean environment such as a clean room.

According to the roller conveyor unit 4 of the embodiment, the conveying path is formed between the left and right side-wall plates 8 and the pallet 2 is conveyed therebetween. Here, the rollers 10 do not extend over the entire width of the conveying path. Therefore, a large gap is present between the left and right rollers 10 to thereby form a large space. By using this space, it is possible to arrange, for example, a stopper mechanism for stopping the pallet 2 and a positioning unit that positions the pallet 2 at a stop position, thereby enhancing the degree of freedom for arranging peripheral devices with respect to the conveying path.

Next, a description is made of a conveyance control method when the roller conveyor unit 4 according to the embodiment is used.

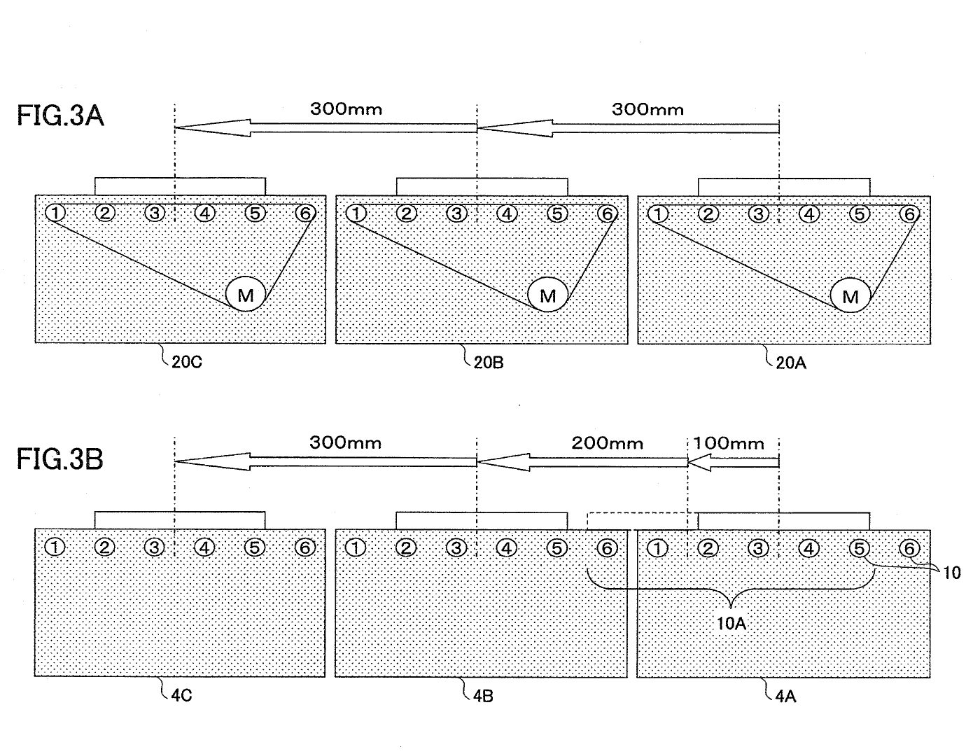

FIGS. 3A and 3B are diagrams showing examples of the conveyance control method for pallets in a case where the roller conveyor units are connected to one another to form the conveying path. FIG. 3A is a diagram showing the conveyance control method in a case where all the rollers of one roller conveyor unit are synchronized to be driven to rotate. FIG. 3B is a diagram showing the conveyance control method that can be performed by the roller conveyor unit according to the embodiment.

In an example shown in FIG. 3A, six rollers are provided to each of three roller conveyor units 20A, 20B, and 20C provided in series, and they are driven by one motor via a belt. Accordingly, all the rollers of one roller conveyor unit are synchronized to rotate at the same speed. In this case, in order to smoothly convey pallets from one roller conveyor unit to the next roller conveyor unit, all the conveying speeds of the roller conveyor units must be the same. Accordingly, all the moving speeds and the moving distances of the pallets on the roller conveyor units must be the same.

For example, when the pallet on the rightmost roller conveyor unit 20A is conveyed to the central roller conveyor unit 20B (moving distance: 300 mm), the pallet on the central roller conveyor unit 20B is also conveyed 30 mm to the leftmost roller conveyor unit 20C. In other words, all the rollers of the three roller conveyor units 20A, 20B, and 20C are caused to simultaneously start their driving at the same speed. The three pallets on the three roller conveyor units 20A, 20B, and 20C are conveyed the same distance at the same speed, and all the rollers of the three roller conveyor units 20A, 20B, and 20C are caused to simultaneously stop their driving.

In the case of the example shown in FIG. 3A, assume that processing, for example, assembling of a workpiece on the pallet, is performed with respect to conveyed objects on the pallets at predetermined positions of the roller conveyor units 20A, 20B, and 20C. Also, assume that processing time at the roller conveyor unit 20B is longer than the processing time at the roller conveyor unit 20A. In this case, even if the processing at the roller conveyor unit 20A is completed first, the pallets cannot be conveyed until the processing at the roller conveyor unit 20B is completed. In other words, the pallets on the roller conveyor units 20A, 20B, and 20C must be simultaneously conveyed after the processing at the roller conveyor unit 20B is completed. Furthermore, because the moving distances of the pallets are 300 mm, conveying time corresponding to 300 mm is required.

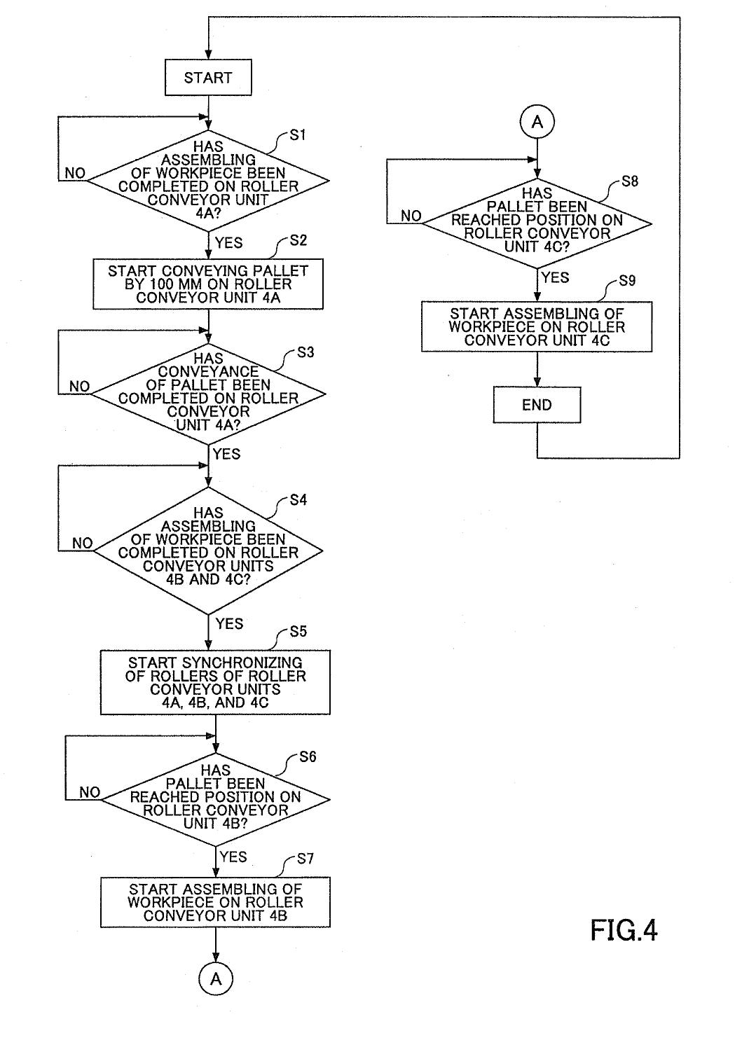

Next, a description is made of the conveyance control method that can be performed by the roller conveyor units 4A, 4B, and 4C according to the embodiment as shown in FIG. 3B. Note that a flowchart for the conveyance control method shown in FIG. 4 is also referred to, besides FIG. 3B.

According to the roller conveyor units 4A, 4B, and 4C of the embodiment, the rotational speeds of the rollers 10 can be separately controlled. Here, similarly to the example shown in FIG. 3A, assume that processing such as assembling a workpiece is performed with respect to conveyed objects on the pallets at predetermined positions of the roller conveyor units 4A, 4B, and 4C and processing time at the roller conveyor unit 4B is longer than processing time at the roller conveyor unit 4A. In this case, unlike the example shown in FIG. 3A, when the processing is first completed with respect to the pallet on the roller conveyor unit 4A (Yes in step S1), it is possible to immediately start conveying the pallet 100 mm in advance (step S2). In other words, only a group 10A of the rollers 10 shown in FIG. 3B is driven to convey only the pallet on the roller conveyor unit 4A 100 mm. The group 10A of the rollers 10 includes the rollers 10 of the roller conveyor unit 4A and one roller 10 of the roller conveyor unit 4B. By driving these rollers simultaneously, it is possible to convey a tip end of the pallet on the roller conveyor unit 4A to the roller conveyor unit 4B.

When only the pallet on the roller conveyor unit 4A is conveyed 100 mm (Yes in step S3), the driving of the group 10A of the rollers 10 is stopped to stop conveying the pallet on the roller conveyor unit 4A and these rollers are caused to wait for the completion of the processing at the roller conveyor units 4B and 4C. When the processing at the roller conveyor units 4B and 4C is completed (Yes in step S4), all the rollers 10 of the roller conveyor units 4A, 4B, and 4C are rotated in synchronization with each other to convey the pallets on the roller conveyor units 4A, 4B, and 4C at the same speed (step S5).

Because the pallet on the roller conveyor unit 4A has already been conveyed 100 mm, it will reach the predetermined position on the roller conveyor unit 4B when conveyed an additional 200 mm after the driving of the rollers 10 is started (Yes in step S6). In the example shown in FIG. 3A, the pallet on the roller conveyor unit 20A is conveyed 300 mm to the position on the roller conveyor unit 20B after the processing at the roller conveyor unit 20B is completed and then the rollers are driven. In the example shown in FIG. 3B, on the other hand, the pallet on the roller conveyor unit 4A is required to be conveyed only an additional 200 mm. In other words, if it is assumed that the pallet is conveyed at the same speed, the pallet on the roller conveyor unit 4A can be conveyed to the position on the roller conveyor unit 4B in two-thirds the time required for conveying the pallet between the roller conveyor units. Accordingly, the conveying time between processes and the entire processing time can be reduced.

Even if the pallet on the roller conveyor unit 4A reaches the position on the roller conveyor unit 4B (Yes in step S6) and the processing at the roller conveyor unit 4B is started (step S7), the conveyance of the pallet previously positioned on the roller conveyor unit 4B is continued. Then, when the pallet on the roller conveyor unit 4B is conveyed 300 mm and reaches the position on the roller conveyor unit 4C (step S8), the driving of the rollers 10 of the roller conveyor unit 4C is stopped and the processing at the roller conveyor unit 4C is started (step S9).

As described above, the conveying path using the roller conveyor unit according to the embodiment makes it possible to convey a conveyed object regardless of another conveyed object on the conveying path. Therefore, the conveyed object ready for conveyance can be conveyed to an adequate position in advance, thereby making it possible to reduce time required for a conveying process. In other words, because the driving of the rollers can be separately controlled, the conveyance of a conveyed object can be separately controlled midway through the conveying path, thereby making it possible to efficiently convey plural conveyed objects and reduce the entire conveying time.

The present invention is not limited to the specifically disclosed embodiment, and variations and modifications may be made without departing from the scope of the present invention.

The present application is based on Japanese Priority Patent Application No. 2007-156431, filed on Jun. 13, 2007, the entire contents of which are hereby incorporated by reference.

What is claimed is:

1. A roller conveyor constituting a conveying path with plural rollers arranged in parallel, the roller conveyor comprising:
the plural rollers in alignment with one another on both sides of the conveying path; and
a roller driving motor provided to each of the rollers, wherein
the rollers are directly linked to rotary shafts of the corresponding roller driving motors.

2. The roller conveyor according to claim 1, wherein
side-wall plates are provided on both sides of the conveying path so as to hold the conveying path between them,
each of the roller driving motors is attached outside the corresponding side-wall plate,
each of the rollers is arranged on a conveying path side of the corresponding side-wall plate, and
each of the rotary shafts of the roller driving motors is connected to the corresponding roller through the corresponding side-wall plate.

3. The roller conveyor according to claim 1, further comprising:
a control part that separately controls a rotational speed of each of the roller driving motors.

4. The roller conveyor according to claim 3, wherein
the roller driving motors are induction motors, and the control part performs frequency control of current to be supplied to the induction motors.

5. The roller conveyor according to claim 3, wherein
the roller driving motors are pulse motors, and the control part performs pulse control of current to be supplied to the pulse motors.

6. A conveyance control method for controlling a conveyance of plural conveyed objects in a conveying path formed by connecting plural roller conveyor units to each other, each roller conveyor unit being composed of the roller conveyor according to claim 3, wherein
one of the plural conveyed objects on the conveying path is stopped at a first roller conveyor unit among the plural roller conveyor units, while another conveyed object on a second roller conveyor unit among the plural roller conveyor units is conveyed across the first roller conveyor unit.

7. The conveyance control method according to claim 6, wherein
some of the rollers of the first roller conveyor unit are driven to rotate in synchronization with the rollers of the second roller conveyor unit.
